(19) United States
(12) Patent Application Publication
(10) Pub. No.: US 2007/0120462 A1
(43) Pub. Date: May 31, 2007

(54) Electron emission device, method of manufacturing the electron emission device, and electron emission display having the electron emission device

(76) Inventors: Il-Hwan Kim, Yongin-si (KR); Chun-Gyoo Lee, Yongin-si (KR); Sang-Jo Lee, Yongin-si (KR); Sang-Hyuck Ahn, Yongin-si (KR); Sang-Ho Jeon, Yongin-si (KR); Su-Bong Hong, Yongin-si (KR); Ki-Hyun Noh, Yongin-si (KR); Ho-Su Han, Yongin-si (KR); Si-Myeong Kim, Yongin-si (KR); Sam-Il Han, Yongin-si (KR); Jin-Hui Cho, Yongin-si (KR)

Correspondence Address: CHRISTIE, PARKER & HALE, LLP, PO BOX 7068, PASADENA, CA, 91109-7068, US

(21) Appl. No.: 11/541,044

(22) Filed: Sep. 29, 2006

(30) Foreign Application Priority Data
Sep. 30, 2005 (KR) 10-2005-0091990
Jun. 16, 2006 (KR) 10-2006-0054457

(51) Int. Cl. H01J 63/04; H01J 1/62

(52) U.S. Cl. 313/496

(57) ABSTRACT

A method of manufacturing the electron emission device is provided. A cathode electrode is formed on a substrate. A first insulation layer of a transparent conductive material is formed on an entire surface of the substrate while covering the cathode electrode. A gate electrode of a transparent conductive material is formed on the first insulation layer in a direction crossing the cathode electrode. A photoresist mask layer is formed on the entire surface of the substrate. An opening corresponding to the opening of the cathode electrode is formed on the photoresist mask layer by emitting ultraviolet light to a rear surface of the substrate and developing the photoresist mask layer. An exposed portion of the gate electrode by the opening of the photoresist mask layer and a portion of the first insulation layer are etched. An electron emission region is formed in the opening of the cathode electrode.

### CROSSED-REFERENCES TO RELATED APPLICATIONS

This application claims priority to and the benefit of Korean Patent Application No. 10-2005-0091990 filed on Sep. 30, 2005, and Korean Patent Application No. 10-2006-0054457 filed on Jun. 16, 2006, both in the Korean Intellectual Property Office, the entire contents of which are incorporated herein by reference.

### BACKGROUND OF THE INVENTION

1. Field of the Invention

The present invention relates to an electron emission device, and more particularly, to an electron emission device having a driving electrode and an insulation layer that are formed in precise patterns, a method of manufacturing the electron emission device, and an electron emission display having the electron emission device.

2. Description of Related Art

A Field Emitter Array (FEA) type of cold cathode electron emission element includes an electron emission region and cathode and gate electrodes that are driving electrodes for controlling the electron emission from the electron emission region. The electron emission regions are formed of a material having a relatively lower work function or a relatively large aspect ratio, such as a molybdenum-based material, a silicon-based material, and a carbon-based material such as carbon nanotubes, graphite, and diamond-like carbon so that electrons can be effectively emitted when an electric field is applied thereto under a vacuum atmosphere.

The electron emission elements are arrayed on a first substrate to form an electron emission device. The electron emission device is combined with a second substrate, on which a light emission unit having phosphor layers and an anode electrode is formed, to establish an electron emission display.

That is, the conventional electron emission device includes electron emission regions and a plurality of driving electrodes functioning as scan and data electrodes. By the operation of the electron emission regions and the driving electrodes, the on/off operation of each pixel and the amount of electron emission are controlled. The phosphor layers are excited by the electrons emitted from the electron emission regions to emit light or display a predetermined image.

The driving electrodes, insulation layer and electron emission region may be stacked upon one another.

Particularly, in the electron emission device having the FEA elements, the cathode electrodes, insulation layer and gate electrodes are successively stacked upon one another in this order. Openings are formed through the gate electrodes and the insulation layer to partly expose a surface of the cathode electrodes. The electron emission regions are formed on the exposed surface of the cathode electrodes through the openings.

In order to form the openings through each layer, a mask layer (e.g., a photoresist mask layer) is required for each layer. In order to form a mask pattern for each layer, a light exposing process and a developing process are performed. At this point, the mask layer for each layer must be accurately aligned with a mask layer for another layer so that the openings formed through the layers can be precisely aligned.

However, as the electron emission device is designed to have a high resolution and large size, it is difficult to align the mask layers with each other using the conventional technology. Therefore, the openings formed through the layers may be misaligned, which causes the final products to be inferior.

### SUMMARY OF THE INVENTION

The present invention provides an electron emission device that can prevent inferiority of the final products and improve the emission uniformity of electron emission regions by minimizing the misalignment between the openings of gate electrodes and the electron emission regions.

The present invention also provides a method of manufacturing the electron emission device.

The present invention also provides an electron emission display that can improve the light emission uniformity of pixels by using the electron emission device.

According to an aspect of the present invention, a method of manufacturing an electron emission device is provided. A cathode electrode is formed on a substrate, the cathode electrode including at least one non-transparent conductive layer provided with an opening. A first insulation layer is formed on an entire surface of the substrate while covering the cathode electrode, the first insulation layer being formed of a transparent material. A gate electrode is formed on the first insulation layer in a direction crossing the cathode electrode, the gate electrode being formed of a transparent conductive material. A photoresist mask layer is formed on the entire surface of the substrate. An opening corresponding to the opening of the cathode electrode is formed on the photoresist mask layer by emitting ultraviolet light to a rear surface of the substrate and developing the photoresist mask layer. An exposed portion of the gate electrode by the opening of the photoresist mask layer and a portion of the first insulation layer, which corresponds to the exposed portion, is etched. An electron emission region is formed in the opening of the cathode electrode.

The cathode electrode may include a first conductive layer that is transparent and a second conductive layer that is non-transparent, the second conductive layer being provided with an opening and stacked on the first conductive layer.

The gate electrode may include a third conductive layer that is transparent and a fourth conductive layer that is non-transparent, the fourth conductive layer having an opening.

A central axis of the opening of the fourth conductive layer may be identical to that of the opening of the second conductive layer and the size of the opening of the fourth conductive layer may be greater than that of the second conductive layer.

The opening of the first insulation layer may be formed through a wet-etching process.

The electron emission region may be formed of a carbon-base material or a nanometer sized material through a screen-printing process.

The electron emission regions may be formed by preparing a paste mixture containing a carbon-base material or a nanometer sized material and a photoresist material, screen-printing the mixture on the entire surface of the substrate, hardening the mixture filled in the opening of the second conductive layer by emitting ultraviolet light to a rear surface of the substrate, and removing the mixture that is not hardened.

The method may further include forming a second insulation layer on the first insulation layer while covering the gate electrode after forming the gate electrode, the second insulation layer being formed of a transparent material. A focusing electrode is formed on the second insulation layer, the focusing electrode having a transparent conductive layer. Corresponding portions of the focusing electrode and second insulation layer are etched to the gate electrode opening of the gate electrode.

The etching of the corresponding portions includes forming a photoresist mask layer on the focusing electrode, forming an opening on the photoresist mask layer by emitting ultraviolet light to a rear surface of the substrate, etching an exposed portion of the focusing electrode by the opening of the photoresist mask layer and a corresponding portion of the second insulation layer to the exposed portion, and removing the photoresist mask layer.

The gate electrode may include a third conductive layer that is transparent and a fourth conductive layer that is non-transparent, the fourth conductive layer having an opening.

A central axis of the opening of the fourth conductive layer may be identical to that of the opening of the second conductive layer and the size of the opening of the fourth conductive layer may be greater than that of the second conductive layer.

The openings of the first and second insulation layers may be formed through a wet-etching process.

The focusing electrode may include a fifth conductive layer that is transparent and a sixth conductive layer that is non-transparent, the sixth conductive layer being stacked on the fifth conductive layer and having an opening.

A central axis of the opening of the sixth conductive layer may be identical to that of the opening of the fourth conductive layer and the size of the opening of the sixth conductive layer may be greater than that of the fourth conductive layer.

The method may further include: forming a second insulation layer on the first insulation layer while covering the gate electrode after forming the gate electrode, the second insulation layer being formed of a transparent material; forming a focusing electrode on the second insulation layer; and partly etching the focusing electrode and the second insulation layer to form openings on the focusing electrode and the second insulation layer at each crossed area of the cathode and gate electrodes.

The gate electrode may include a third conductive layer that is transparent and a fourth conductive layer that is non-transparent, the fourth conductive layer having an opening.

A central axis of the opening of the fourth conductive layer may be identical to that of the opening of the second conductive layer and the size of the opening of the fourth conductive layer may be greater than that of the second conductive layer.

The openings of the first and second insulation layers may be formed through a wet-etching process.

The cathode electrode may include a resistive layer having an opening and a conductive layer stacked on the resistive layer and spaced apart from the opening of the resistive layer.

The forming of the electron emission region may include etching an exposed portion of the gate electrode by the opening and a corresponding portion of the first insulation layer to the exposed portion; forming a second photoresist layer on a resulting structure on the substrate; forming an opening on the second photoresist layer through a photolithography process; and forming an electron emission material in the opening of the resistive layer through a deposition process.

The resistive layer may be formed of amorphous silicon and the conductive layer may be formed of metal.

The resistive layer may be formed in a stripe pattern and the conductive layer may be formed along both side peripheries of the resistive layer.

The opening of the first insulation layer may be formed through a wet-etching process and the gate electrode may be further etched after the first insulation layer may be etched, thereby making the size of the opening of the insulation layer identical to that of the opening of the gate electrode.

The electron emission regions may be formed by preparing a paste mixture containing an electron emission material and a photoresist material, depositing the mixture on the second photoresist layer, selectively hardening the mixture filled in the opening of the resistive layer through a rear surface exposing process, removing the mixture that is not hardened, and drying and baking the mixture filled in the opening of the resistive layer.

The method may further include, after the electron emission region may be formed, partly removing a surface of the electron emission region to activate the electron emission region.

A light blocking mask may be arranged on the rear surface of the substrate between the cathode electrodes during the rear surface exposing process for forming the opening of the photoresist mask.

The method may further include, after the gate electrode may be formed, forming a second insulation layer and a focusing electrode and partly etching the focusing electrode and the second insulation layer to form openings on the focusing electrode and the second insulation layer.

Sizes of the focusing electrode and second insulation layer may be formed to be greater than those of the gate electrode and insulation layer.

The focusing electrode may be formed of a non-transparent metal material to function as a light blocking mask during a process for exposing the second photoresist layer.

According to another exemplary embodiment of the present invention, there is provided an electron emission device including: a substrate; a cathode electrode formed on the substrate and including at least one non-transparent conductive layer having an opening; an electron emission region filled in the opening; and a gate electrode disposed above the cathode electrode and provided with an opening exposing the electron emission region, the gate electrode being transparent.

The cathode electrode may include a first conductive layer that is transparent and a second conductive layer that is non-transparent, the second conductive layer being provided with an opening and stacked on the first conductive layer; and the electron emission region may be filled in the opening of the second conductive layer on the first conductive layer.

The gate electrode may include a third conductive layer that is transparent and a fourth conductive layer that is non-transparent, the fourth conductive layer having an opening and being stacked on the third conductive layer.

A central axis of the opening of the fourth conductive layer may be identical to that of the opening of the second conductive layer and the size of the opening of the fourth conductive layer may be greater than that of the second conductive layer.

The electron emission device may further include a second insulation layer formed on the first insulation layer while covering the gate electrode and a focusing electrode formed on the second insulation layer, the focusing electrode having a transparent conductive layer.

The focusing electrode may include a fifth conductive layer that is transparent and a sixth conductive layer that is non-transparent, the sixth conductive layer being stacked on the fifth conductive layer and having an opening.

The second insulation layer and the focusing electrode may be provided with openings corresponding to the electron emission region.

The cathode electrode may include a resistive layer having an opening and a conductive layer stacked on the resistive layer while exposing the opening of the resistive layer and the electron emission region contacts the resistive layer and may be filled in the opening of the resistive layer so that a central axis of the electron emission region is self-aligned with that of the opening of the gate electrode.

The central axis of the electron emission region may be deviated from the central axis of the opening of the gate electrode by less than 0.5 μm.

In still another exemplary embodiment of the present invention, there is provided an electron emission display including: an electron emission device including a first substrate, a cathode electrode formed on the substrate and including at least one non-transparent conductive layer having an opening, an electron emission region filled in the opening, and a gate electrode disposed above the cathode electrode and provided with an opening exposing the electron emission region, the gate electrode being transparent; a second substrate facing the first substrate; a phosphor layer formed on the second substrate; and an anode electrode formed on the phosphor layer.

### BRIEF DESCRIPTION OF THE DRAWINGS

FIGS. 1A, 1B, 1C, 1D, 1E and 1F are sectional views illustrating a method of manufacturing an electron emission device according to an embodiment of the present invention.

FIGS. 2A, 2B, 2C, 2D, 2E and 2F are sectional views illustrating a method of manufacturing an electron emission device according to another embodiment of the present invention.

FIGS. 3A, 3B, 3C, 3D and 3E are sectional views illustrating a method of manufacturing an electron emission device according to another embodiment of the present invention.

FIG. 4 is a partially broken, exploded perspective view of an electron emission display according to an embodiment of the present invention.

FIG. 5 is a partial sectional view of the electron emission display of FIG. 4.

FIG. 6 is a partially broken, exploded perspective view of an electron emission display according to another embodiment of the present invention.

FIG. 7 is a partially broken, exploded perspective view of an electron emission display according to another embodiment of the present invention.

FIGS. 8A, 8B, 8C, 8D, 8E, 8F, 8G, 8H, 8I, 8J and 8K are sectional views illustrating a method of manufacturing an electron emission device according to another embodiment of the present invention.

FIG. 9 is an enlarged photograph showing a top surface of the electron emission device manufacturing by the method of FIGS. 8A through 8K.

FIGS. 10A, 10B, 10C, 10D, 10E, 10F, 10G and 10H are sectional views illustrating a method of manufacturing an electron emission device according to another embodiment of the present invention.

FIG. 11A is a partially broken, exploded perspective view of an electron emission display having the electron emission device manufactured by the method of FIGS. 8A through 8K.

FIG. 11B is an enlarged view of a portion A of FIG. 11A.

FIG. 12 is a partial sectional view of the electron emission display of FIG. 11A.

FIG. 13 is a partial sectional view of an electron emission display having the electron emission device manufactured by the method of FIGS. 10A through 10H.

### DETAILED DESCRIPTION OF INVENTION

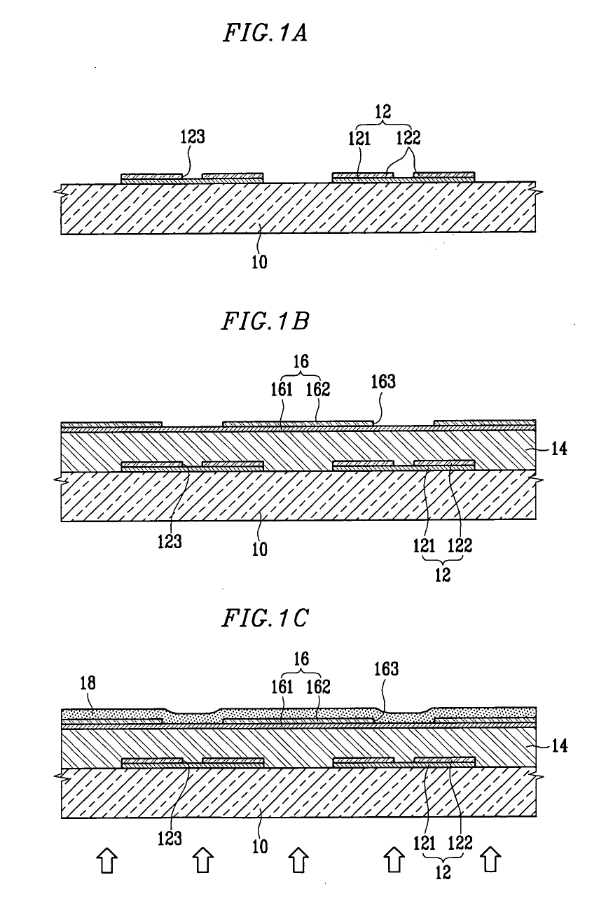

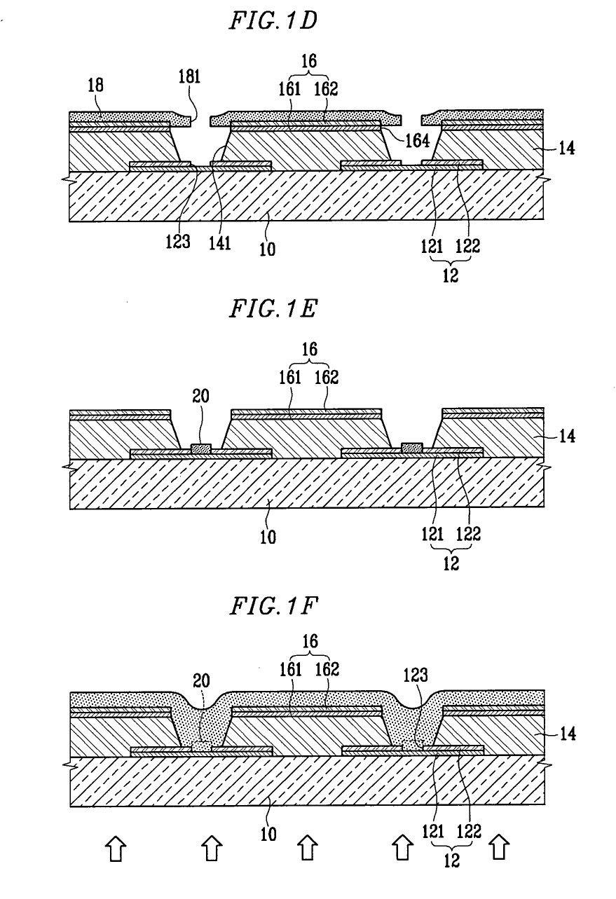

Referring first to FIG. 1A, a first conductive layer 121 is coated on a substrate 10 in a stripe pattern using a transparent conductive material such as indium thin oxide (ITO). A second conductive layer 122 is coated on the first conductive layer 121 in a predetermined pattern using a non-transparent conductive material such as metal. The second conductive layer 122 is provided with a central opening 123.

The first and second conductive layers 121, 122 function as cathode electrodes 12. The central opening 123 exposes partly a surface of the first conductive layer 121 so as to form an electron emission region, which can be formed on the exposed surface of the first conductive layer 121. Because the second conductive layer 122 is formed of a material having an electric resistance lower than that of the first conductive layer 121, the line resistance of the cathode electrodes 12 can be lowered. Furthermore, because the second conductive layer 122 does not transmit the light, it can function as an exposing mask in the following process.

Referring to FIG. 1B, an insulation material is deposited on the substrate 10 while covering the cathode electrodes 12 to form an insulation layer 14 having a predetermined thickness. The insulation layer 14 can be formed through a chemical vapor deposition or screen-printing process. The insulation material may be a material that can transmit an ultraviolet ray.

A transparent conductive material such as the ITO is coated on the insulation layer in a stripe pattern to form a third conductive layer 161 crossing the cathode electrodes 12 at right angles. A non-transparent material such as metal is coated on the third conductive layer 161 in a predetermined pattern to form a fourth conductive layer 162 having an opening 163. The third and fourth conductive layers 161, 162 function as gate electrodes 16.

Likewise, because the fourth conductive layer 162 is formed of a material having an electric resistance lower than that of the third conductive layer 161, the line resistance of the gate electrodes 16 can be lowered. Furthermore, because the fourth conductive layer 162 is designed not to transmit the light, it can function as an exposing mask in the following process. The opening 163 of the fourth conductive layer 162 may be formed to have a central axis identical to that of the opening 123 of the second conductive layer 122 but has a size greater than that of the opening 123 of the second conductive layer 122.

At this point, the fourth conductive layer 162 corresponds to a portion between the cathode electrodes 12 to block a light path of light passing through the portion between the cathode electrodes 12.

Referring to FIG. 1C, a photoresist mask layer 18 is formed on the substrate 10 while covering the insulation layer 14 and the gate electrodes 16. The photoresist mask layer 18 is formed in a positive type where the exposed portion is melted and removed. An ultraviolet ray is emitted to a rear surface of the substrate 10 to expose the photoresist mask layer 18. At this point, because the ultraviolet ray reaches the photoresist mask layer 18 only through the opening 123 of the second conductive layer and the opening 163 of the fourth conductive layer 162, only a portion of the photoresist mask layer 18, which corresponds to the opening 123 of the second conductive layer 122, is exposed.

Referring to FIG. 1D, the photoresist mask layer 18 is developed to form an opening 181 by removing the exposed portion. Then, an exposed portion of the third conductive layer 161 by the opening 181 and a portion of the insulation layer 14, which corresponds to the exposed portion of the third conductive layer 161, are etched to form openings 164, 141. At this point, the insulation layer 14 may be etched through a wet-etching process. In this case, an under-cut is formed under the photoresist mask layer 18 such that the size of the opening 141 of the insulation layer 14 is greater than that of the opening 181 of the photoresist mask layer 18, thereby exposing a portion of a surface of the second conductive layer 122.

Referring to FIG. 1E, the photoresist mask layer 18 is removed and an electric emission material is filled in the opening 123 of the second conductive layer 122 to form the electron emission region 20. The electron emission region 20 may be formed of a material, which emits electrons when an electric field is applied thereto under a vacuum atmosphere, such as a carbonaceous material or a nanometer-sized material. For example, the electron emission region 20 may be formed of carbon nanotubes, graphite, graphite nanofibers, diamonds, diamond-like carbon, C₆₀, silicon nanowires, or a combination thereof.

The electron emission region 20 is generally formed by screen-printing a paste mixture containing an electron emission material, vehicle and binder in the opening 123 of the second conductive layer 122 and drying and baking the printed paste mixture.

Alternatively, a photosensitive material may be further contained in the paste mixture, and as shown in FIG. 1F, the paste mixture containing the photosensitive material is screen-printed on an entire surface of the substrate 10. Then, the ultraviolet ray is emitted to the rear surface of the substrate to selectively harden the paste mixture printed in the opening 123 of the second conductive layer 122. Then, the paste mixture that is not hardened is removed, thereby forming the electron emission region 20. In this case, because the electron emission region 20 is hardened from a surface of the first conductive layer 121, the bonding force of the electron emission region 20 to the cathode electrode 12 can be enhanced.

Alternatively, the electron emission region 20 may be formed through a direct-growth process, a chemical vapor deposition process, or a sputtering process.

According to the above-described method of manufacturing the electron emission device, the second conductive layer 122 functioning as the cathode electrodes 12 is used as the exposing mask, and therefore the openings and electron emission region that will be formed in the following processes can be automatically aligned.

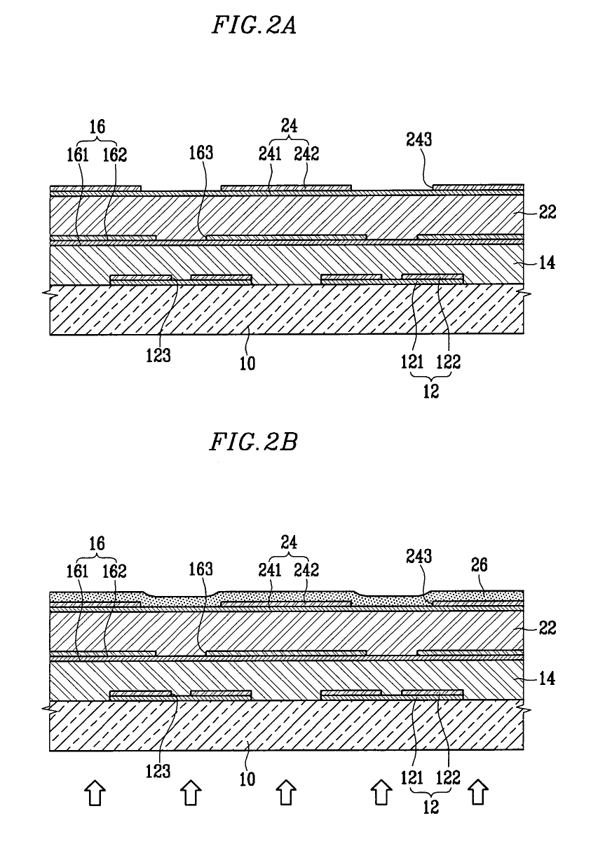

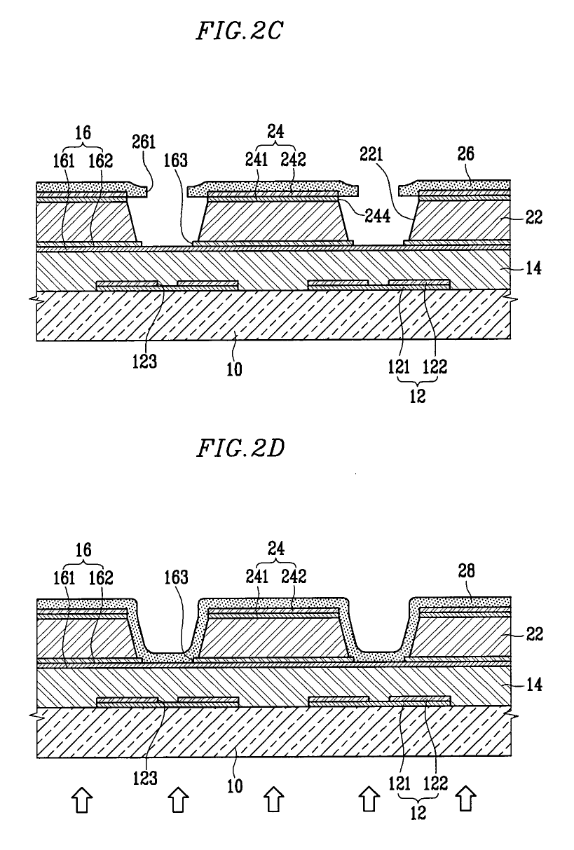

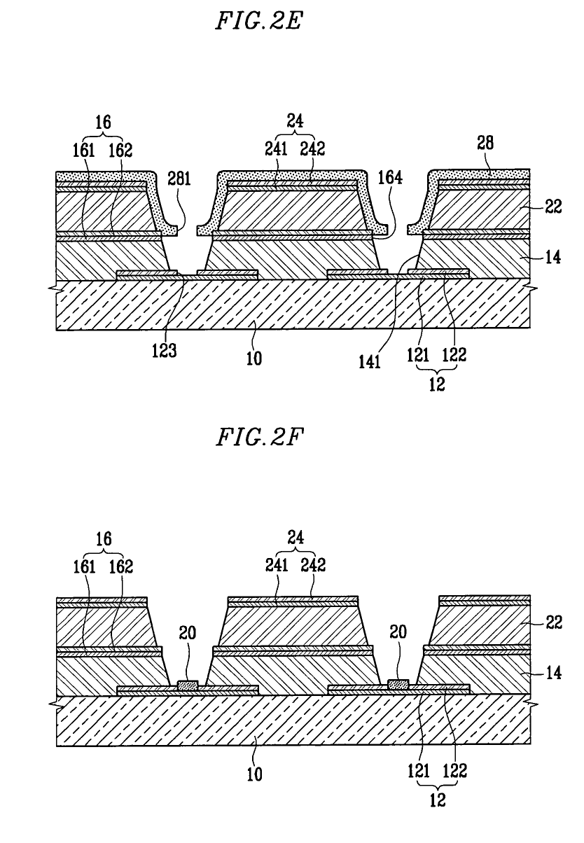

FIGS. 2A through 2F show a method of manufacturing an electron emission device according to another embodiment of the present invention.

Referring first to FIG. 2A, as in the foregoing embodiment of FIG. 1A through 1F, first and second conductive layers 121, 122 are formed on a substrate 10 to form the cathode electrodes 12 and an insulation material is deposited on the substrate 10 while covering the cathode electrodes 12 to form a first insulation layer 14. Then, gate electrodes 16 formed by third and fourth conductive layers 161, 162 are formed on the first insulation layer 14. A second insulation layer 22 is formed on the first insulation layer while covering the gate electrodes 16 and a focusing electrode 24 is formed on the second insulation layer 22.

The focusing electrode 24 may be formed of a transparent conductive material such as the ITO. Alternatively, the focusing electrode 24 may be formed by a fifth conductive layer 241 formed of a transparent material and a sixth conductive layer 242 stacked on the fifth conductive layer 241 and formed of a non-transparent material. In this case, the sixth conductive layer 242 may be formed of metal, for example, and provided with an opening 243 aligned with the opening 123 of the second conductive layer 122 and the opening 163 of the fourth conductive layer 162. The size of the opening 243 of the sixth conductive layer 242 may be greater than that of the opening 163 of the fourth conductive layer 162.

Referring to FIG. 2B, a first photoresist mask layer 26 is formed on the entire surface of the substrate 10 while covering the focusing electrode 24 and then the ultraviolet ray is emitted through a rear surface of the substrate 10. At this point, the ultraviolet ray reaches the first photoresist mask layer 26 only through the openings 123, 163, 243 of the respective second, fourth and sixth conductive layers 122, 162, 242. Therefore, only an exposed portion of the first photoresist mask layer 26 by the openings 123, 163, 243 receives the ultraviolet layer.

Referring to FIG. 2C, the exposed portion of the first photoresist mask layer 26 is removed through a developing process to form an opening 261 on the first photoresist mask layer 26. An exposed portion of the fifth conductive layer 241 by the opening 261 of the first photoresist mask layer 26 and a portion of the second insulation layer 22, which corresponds to the exposed portion of the fifth conductive layer 241, are etched to form openings 244, 221. At this point, the second insulation layer 22 may be etched through a wet-etching process. In this case, an under-cut is formed under the first photoresist mask layer 26 such that the size of the opening 221 of the second insulation layer 22 is greater than that of the opening 261 of the first photoresist mask layer 26, thereby exposing a portion of the surface of the second conductive layer 122.

Then, the first photoresist mask layer 26 is removed and, as shown in FIG. 2D, a second photoresist mask layer 28 is formed on an entire surface of the resulting structure formed on the substrate 10. The ultraviolet ray is emitted again through a rear surface of the substrate 10. Then, a portion of the second photoresist mask layer 28, which corresponds to the opening 123 of the second conductive layer 122, is selectively exposed to the ultraviolet ray.

Referring to FIG. 2E, the exposed portion of the second photoresist mask layer 28 is exposed to form an opening 281. An exposed portion of the third conductive layer 161 by the opening 281 of the photoresist mask layer 28 and a portion of the first insulation layer 14, which corresponds to the exposed portion of the third conductive layer 161, are etched to form openings 164, 141. At this point, the first insulation layer 14 may be etched through the wet-etching process. Likewise, an under-cut is formed under the second photoresist mask layer 28 such that the size of the opening 141 of the insulation layer 14 is greater than that of the opening 281 of the second photoresist mask layer 28.

Referring to FIG. 2F, the second photoresist mask layer 28 is removed and electron emission material is filled in the opening 123 of the second conductive layer 122 to form an electron emission region 20. The method of forming the electron emission region 20 is identical to that described in the foregoing embodiment of FIGS. 1A through 1F.

As described above, even when the second insulation layer 22 and the focusing electrode 24 are further provided, the second conductive layer 122 functioning as the cathode electrodes 12 functions as the exposing mask and thus the position where the electron emission region 20 is formed can be automatically aligned with the openings of the first photoresist mask layer 26, second insulation layer 22, second photoresist mask layer 28, and first insulation layer 14.

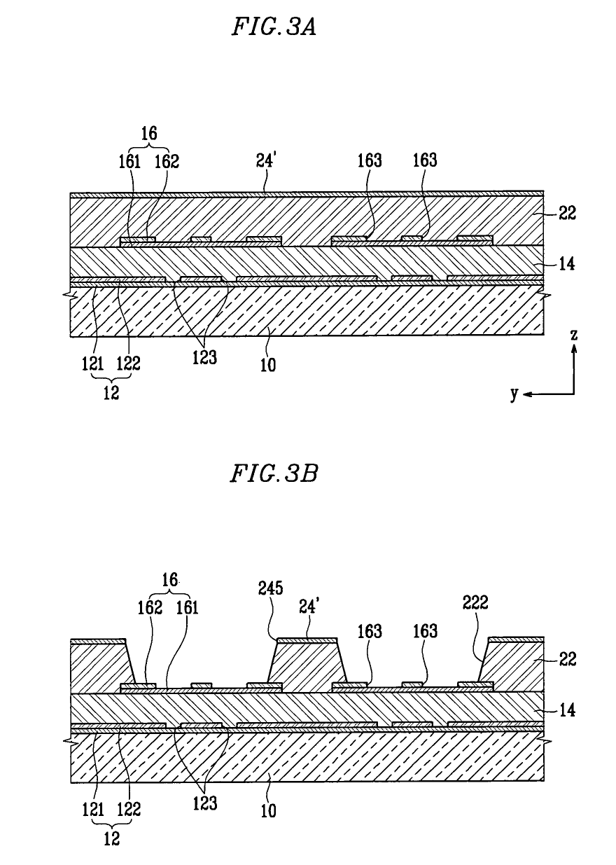

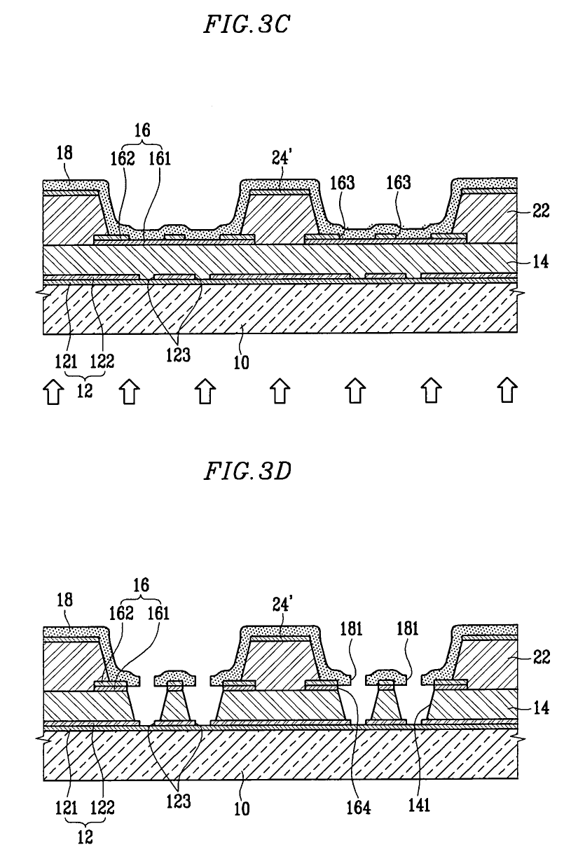

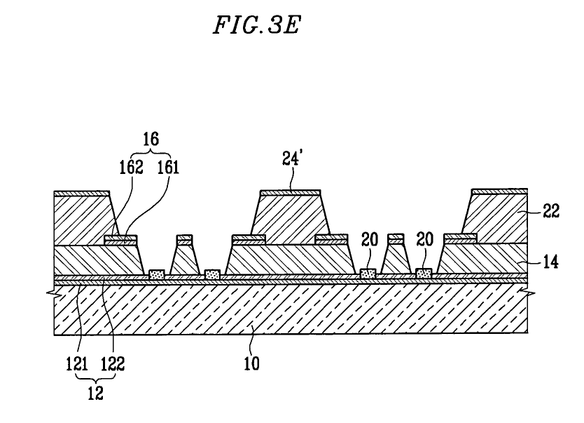

FIGS. 3A through 3E show a method of manufacturing an electron emission device according to another embodiment of the present invention.

Referring first to FIG. 3A, as in the foregoing embodiment of FIG. 1A through 1F, first and second conductive layers 121, 122 are formed on a substrate 10 to form the cathode electrodes 12 and an insulation material is deposited on the substrate 10 while covering the cathode electrodes 12 to form a first insulation layer 14. Then, gate electrodes 16 formed by third and fourth conductive layers 161, 162 are formed on the first insulation layer 14. A second insulation layer 22 is formed on the first insulation layer while covering the gate electrodes 16 and a focusing electrode 24′ is formed on the second insulation layer 22.

A plurality of openings, i.e., openings 123, 163 are formed on the second and fourth conductive layers 122, 162 at each crossed area of the cathode and gate electrodes 12, 16 along a y-axis in FIG. 3A.

Referring to FIG. 3B, the focusing electrode 24′ and the second insulation layer 22 are etched through a well-known photolithography process to form openings 245, 222 at each crossed area of the cathode and gate electrodes 12, 16.

Referring to FIG. 3C, a photoresist mask layer 18 is formed on an entire surface of a resulting structure formed on the substrate 10 and the ultraviolet ray is emitted through a rear surface of the substrate 10. Then, a portion of the photoresist mask layer 18, which corresponds to the openings 123, 163 of the respective second and fourth conductive layers 122, 162, is selectively exposed to the ultraviolet ray.

Referring to FIG. 3D, the photoresist mask layer 18 is developed to form an opening 181 by removing the exposed portion. Then, an exposed portion of the third conductive layer 161 by the opening 181 and a portion of the insulation layer 14, which corresponds to the exposed portion of the third conductive layer 161, are etched to form openings 164, 141 through the respective third conductive layer 161 and insulation layer 14.

Referring to FIG. 3E, finally, the photoresist mask layer 18 is removed and an electric emission material is filled in the opening 123 of the second conductive layer 122 to form the electron emission region 20. The method of forming the electron emission region 20 is identical to that of the foregoing embodiment of FIGS. 1A through 1F.

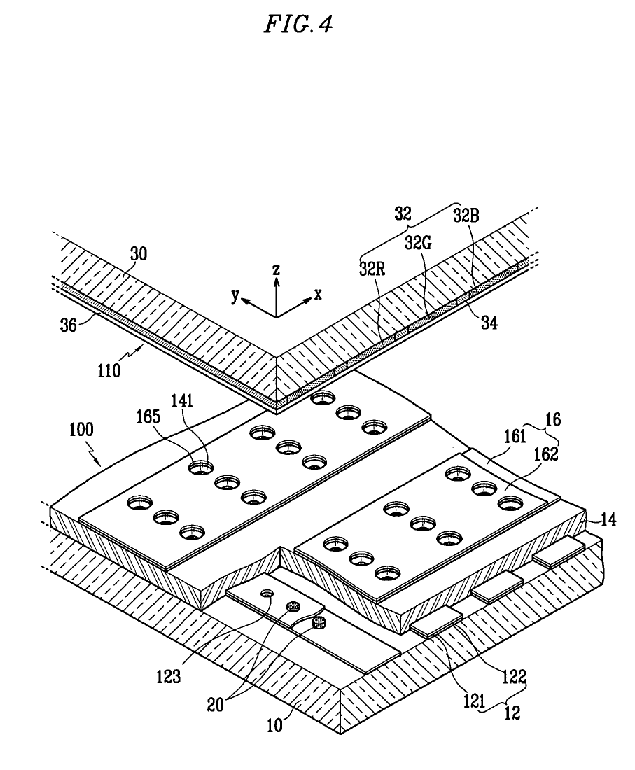

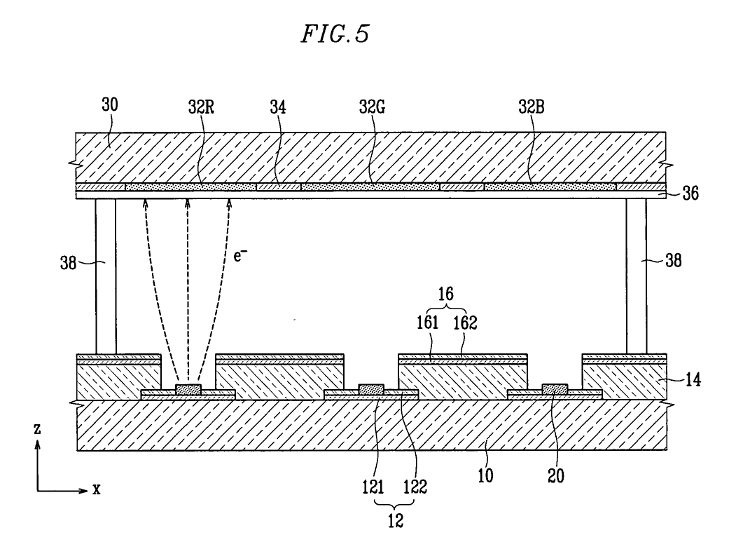

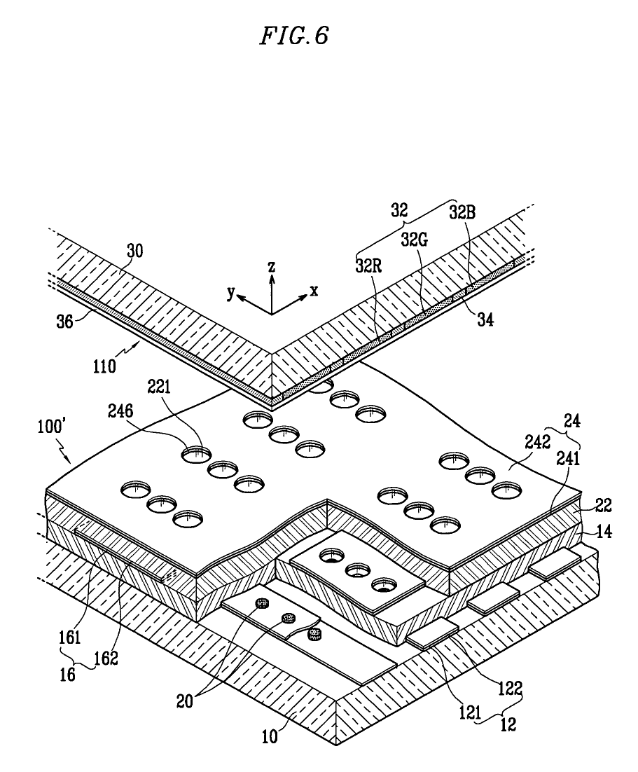

FIGS. 4 and 5 show an electron emission display having the electron emission device manufactured according to the method described with reference to FIGS. 1A through 1F.

Referring to FIGS. 4 and 5, an electron emission display includes first and second substrates 10, 30. The first and second substrates 10, 30 are sealed together at their peripheries using a sealing member (not shown). An inner space defined by the first and second substrates 10, 30 are exhausted to be kept to a degree of vacuum of about 10⁻⁶ torr.

Electron emission elements are arrayed on a surface of the first substrate 10 facing the second substrate 30 to form an electron emission device 100. The electron emission device 100 is combined with the second substrate 30 and a light emission unit provided on the second substrate 30, thereby forming the electron emission display.

A plurality of cathode electrodes 12 are arranged on the first substrate 10 in a stripe pattern extending in a direction of the first substrate 10 and an insulation layer 14 is formed on the first substrate 10 to cover the cathode electrodes 12. A plurality of gate electrodes 16 are arranged on the insulation layer 14 in a stripe pattern extending in a direction crossing the cathode electrodes 12 at right angles.

The cathode electrodes 12 include a first conductive layer 121 formed of a transparent material and a second conductive layer 122 formed of a non-transparent material and stacked on the first conductive layer 121. The gate electrodes 16 include a third conductive layer 161 formed of a transparent material. The gate electrodes 16 may further include a fourth conductive layer 162 formed of a non-transparent material and stacked on the third conductive layer 161. The first and third conductive layers 121, 161 may be formed of ITO and the second conductive layer 122 and fourth conductive layer 162 may be formed of metal such as Cr, Cu, Ni, Ag, or Al.

Defining each crossed area of the cathode and gate electrodes 12, 16 as a unit pixel area, one or more openings 123 are formed on the second conductive layer 122 at each unit pixel area to partly expose the first conductive layer 121. Openings 165, 141 corresponding to the openings 123 are formed through the gate electrodes 16 and the insulation layer 14. At this point, the openings 165, 141 of the gate electrodes 16 and the insulation layer 14 are greater in size than those of the openings 123 of the second conductive layer 122 to partly expose a surface of the second conductive layer 122.

Electron emission regions 20 are formed on the first conductive layer 121 through the openings of the second conductive layer 122.

In the above structure, because the second conductive layer 122 functions as an exposing mask, the openings 141, 165 of the insulation layer 14 and gate electrodes 16 can be automatically aligned with the opening 123 of the second conductive layer during the process for forming the openings 141, 165. Therefore, a precise pattern can be formed. In addition, the second and fourth conductive layers 122, 162 reduce the line resistance of the gate electrodes 16, thereby suppressing the voltage drop.

Phosphor layers 32 such as red, green and blue phosphor layers 32R, 32G, 32B are formed on a surface of the second substrate 30 facing the first substrate 10 and a black layer 34 for enhancing the contrast of the image are formed between the phosphor layers 32.

An anode electrode 36 formed of a conductive material such as aluminum is formed on the phosphor and black layers 32, 34. The anode electrode 36 functions to heighten the screen luminance by receiving a high voltage required for accelerating the electron beams and reflecting the visible rays radiated from the phosphor layers 32 to the first substrate 10 toward the second substrate 30.

Alternatively, the anode electrode may be formed of a transparent conductive material, such as Indium Tin Oxide (ITO), instead of the metallic material. In this case, the anode electrode is placed on the second substrate and the phosphor and black layers are formed on the anode electrode. In addition, the anode electrode is divided into a plurality of sections arranged in a predetermined pattern.

Disposed between the first and second substrates 10, 30 are spacers 38 (see FIG. 5) for uniformly maintaining a gap between the first and second substrates 10, 30. The spacers are formed on the black layer 34 so as not to interfere with the emission of the phosphor layers 32.

The above-described electron emission display is driven by applying voltages to the cathode electrodes 12, gate electrodes 16 and anode electrode 36. For example, one of the cathode and gate electrodes 12, 16 receives a scan drive voltage to function as a scan electrode and the other receives a data drive voltage to function as a data electrode. The anode electrode 36 receives hundreds through thousands of volts of a positive DC voltage to accelerate the electron beam.

Then, an electric field is formed around the electron emission regions corresponding to the pixels where a voltage difference between the cathode and gate electrodes 12, 16 is higher than a threshold value and thus the electric emission regions emit electrons. The emitted electrons strikes the corresponding phosphor layers 32 by the high voltage applied to the anode electrode, thereby exciting the phosphor layers 32.

FIG. 6 shows an electron emission display having the electron emission device manufactured according to the methods described with reference to FIG. 2A through 2F.

Referring to FIG. 6, an electron emission display of this embodiment is substantially identical to that shown in FIGS. 4 and 5 except that an electron emission device 100′ further includes a second insulation layer 22 and a focusing electrode 24.

The focusing electrode 24 includes a fifth conductive layer 241 formed of a transparent material and a sixth conductive layer 242 formed of a non-transparent material and stacked on the fifth conductive layer 241. The focusing electrode 24 and the second insulation layer 22 are provided with openings 246, 221 for exposing the electron emission regions 20.

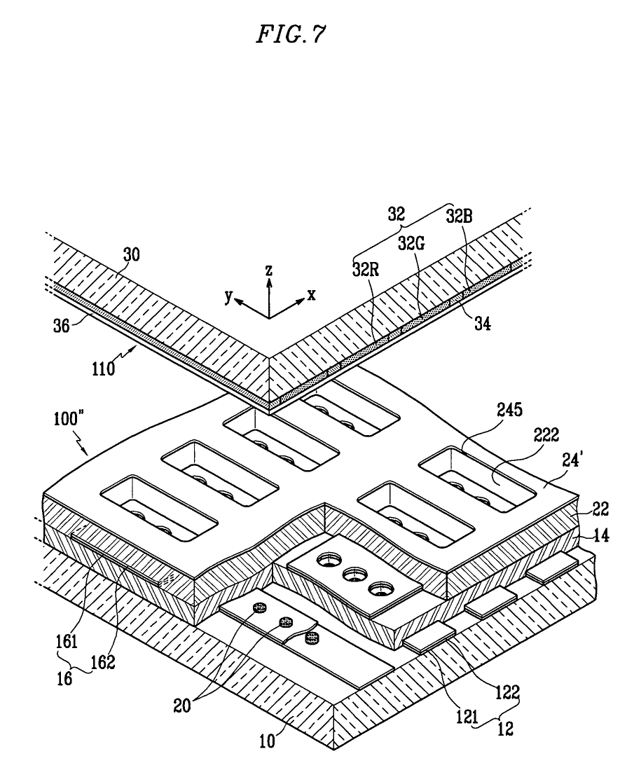

FIG. 7 shows an electron emission display having the electron emission device manufactured according to the methods described with reference to FIG. 3A through 3E.

Referring to FIG. 7, an electron emission display of this embodiment is substantially identical to that shown in FIGS. 4 and 5 except that an electron emission device 100″ further includes a second insulation layer 22 and a focusing electrode 24′.

The focusing electrode 24′ is formed of a single layer that is transparent or non-transparent. The focusing electrode 24′ and the second insulation layer 22 provided with openings 245, 222 corresponding to the plurality of electron emission regions 20 at each pixel area.

The focusing electrode 24 (FIG. 6), 24′ (FIG. 7) receives 0 or several to tens of volts of a negative DC voltage to focus the electron beams passing through the openings 246 (FIG. 6), 245 (FIG. 7).

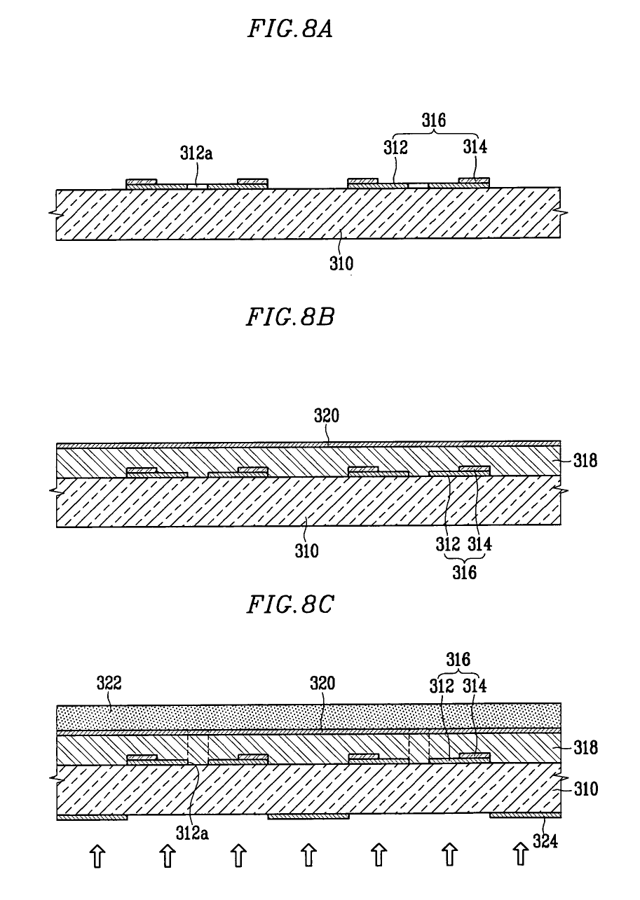

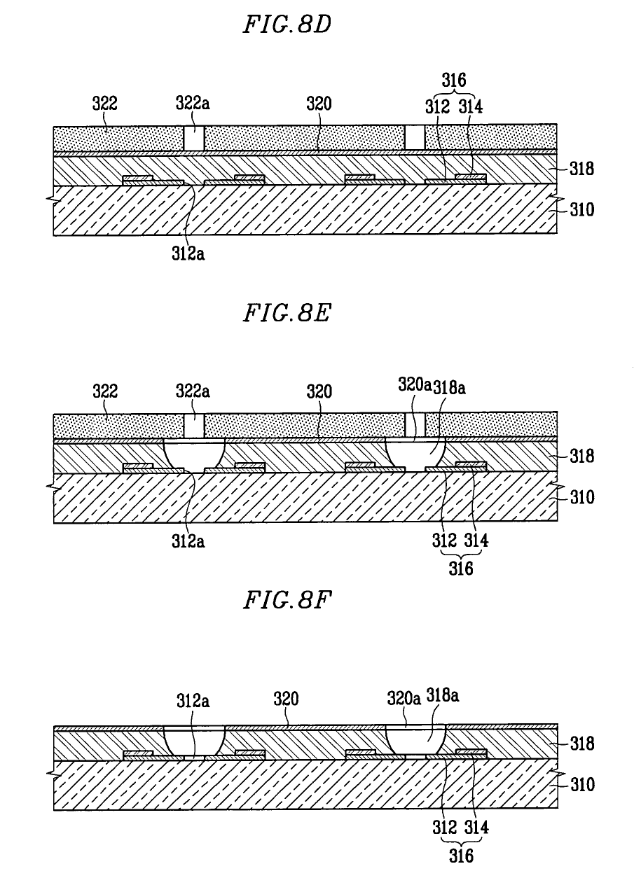

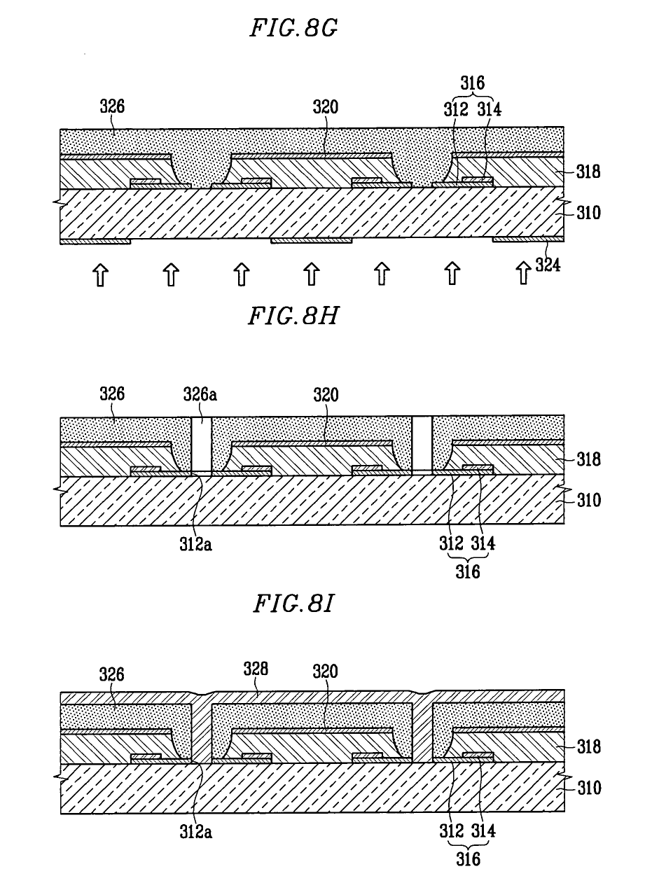

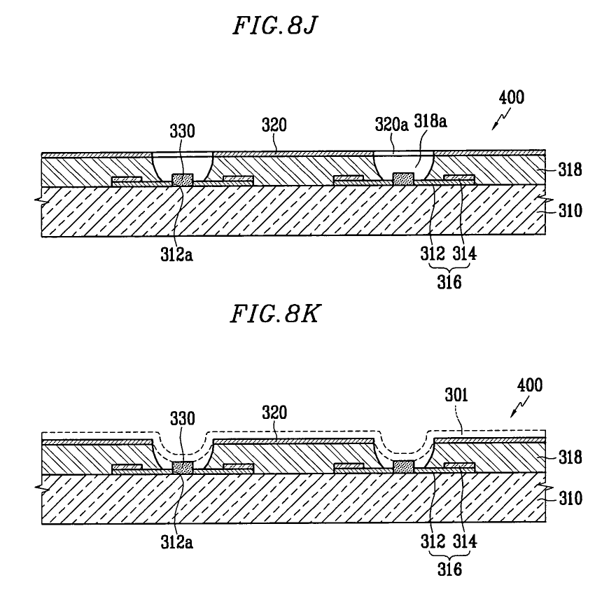

FIGS. 8A through 8K show a method of manufacturing an electron emission device according to another embodiment of the present invention.

Referring to FIG. 8A, a resistive material is coated on the substrate 310 in a stripe pattern to form a resistive layer 312 and an opening 312a is formed through the resistive layer 312.

The opening 312a of the resistive layer 312 is formed to correspond to a portion where an electron emission region will be formed. The resistive layer 312 may be formed of amorphous silicon doped with p-type or n-type impurities. The resistive layer 312 may have a resistance of about 10,000-100,000 Ωcm.

Then, a conductive layer 314 is formed on the resistive layer 312 to form cathode electrodes 316. That is, the cathode electrodes 316 include the resistive layer 312 and the conductive layer 314. The conductive layer 314 is formed of metal having a low electric conductivity. The conductive layer 314 is formed on both side peripheries of the resistive layer 312. Alternatively, the conductive layer may be posited under the resistive layer.

Referring to FIG. 8B, an insulation layer 318 is formed by depositing an insulation material on the entire surface of the substrate 310 to cover the cathode electrodes 316. The insulation layer 318 may be formed through a chemical vapor deposition or screen-printing process. The insulation layer 318 is formed of a material that can transmit ultraviolet light.

A transparent conductive material such as indium tin oxide (ITO) or indium zinc oxide (IZO) is coated on the insulation layer 318 in a stripe to form gate electrodes 320 crossing the cathode electrodes 316 at right angles.

Referring to FIGS. 8C and 8D, a first photoresist layer 322 functioning as a mask layer is formed on an entire surface of the substrate 310 to cover the insulation layer 318 and the gate electrodes 320. The first photoresist layer 322 is a positive type where the exposed portion is melted and removed.

A light blocking mask 324 is disposed on a rear surface of the substrate 310 to correspond to portions defined between the cathode electrodes 316 and ultraviolet light is emitted to the rear surface of the substrate 310.

At this point, because the resistive layer 312 functions as a mask for blocking the ultraviolet light, the ultraviolet light can reach the first photoresist layer 322 only through the opening 312a of the resistive layer 312, thereby selectively exposing the first photoresist layer 322. The exposed portion of the first photoresist layer 322 is removed through a developing process, thereby forming an opening 322a.

Referring to FIGS. 8E and 8F, an exposed portion of the gate electrode 320 by the opening 322a of the first photoresist layer 322 and a portion of the insulation layer 318, which corresponds to the exposed portion of the gate electrode 320 are successively etched to form openings 320a, 318a on the gate electrode 320 and the insulation layer 318. Then, the first photoresist layer 322 is removed.

When the insulation layer 318 is etched through a wet-etching process, the size of the opening 318a at a top surface of the insulation layer 318 is greater than that of the opening 320a of the gate electrode due to the isotropic etching. Therefore, after the insulation layer 318 is etched, the gate electrode 320 is further etched to make the size of the opening 320a identical to the opening 318a of the insulation layer 318.

Referring to FIGS. 8G and 8H, a second photoresist layer 326 functioning as a sacrifice layer is formed on an entire surface of the substrate 310. The second photoresist layer 326 is also formed in the positive type. The light blocking mask 324 is disposed again on a rear surface of the substrate 310 to correspond to portions defined between the cathode electrodes 316 and ultraviolet light is emitted to the rear surface of the substrate 310.

At this point, because the resistive layer 312 functions as a mask for blocking the ultraviolet light, the ultraviolet light can reach the second photoresist layer 326 only through the opening 312a of the resistive layer 312, thereby selectively exposing the second photoresist layer 326. The exposed portion of the second photoresist layer 326 is removed through a developing process, thereby forming an opening 326a by which a portion where the electron emission region will be formed is exposed.

Referring to FIG. 8I, a paste mixture 328 containing an electron emission material and a photoresist material is screen-printed on the second photoresist layer 326 and the ultraviolet light is emitted to a rear surface of the substrate 310 to selectively harden the mixture filled in the opening 312a of the resistive layer 312.

After the mixture that is not hardened and the second photoresist layer 326 are removed, the hardened mixture is dried and baked.

Then, as shown in FIG. 8J, the electron emission region 330 is formed on the opening 312a of the resistive layer 312, thereby completing an electron emission device 400. The electron emission regions 330 may be formed of carbon nanotubes, graphite, graphite nanofibers, diamonds, diamond-like carbon, C₆₀, silicon nanowires, or a combination thereof.

Because the electron emission region 330 is hardened through a rear surface exposing process, the bonding force of the electron emission region 330 to the substrate 310 can be enhanced. The electron emission region 330 contacts the resistive layer 312 to receive an electric current required for emitting electrons from the conductive layer 314.

Referring to FIG. 8K, if required, an activation process in which a viscosity tape 301 is attached on the substrate 310 and removed from the substrate 310 may be performed to improve the electron emission efficiency of the electron emission region 330 by vertically orienting the electron emission materials. Instead of using the viscosity tape 301, the activation process may be performed through a soft rubber rolling process or by applying an electric filed to the electron emission region 330.

According to the above-described method, through the patterning processes for the first and second photoresist layers 322, 326, the central axes of the openings 320a, 318a of the gate electrode 320 and insulation layer 318 and the central axis of the electron emission region 330 can be aligned with the central axis of the opening 312a of the resistive layer 312. As a result, the central axis of the electron emission region 330 can be exactly aligned with the central axis of the opening 320a of the gate electrode 320.

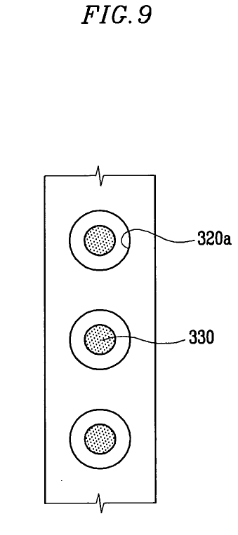

FIG. 9 is an enlarged photograph illustrating a top surface of the electron emission device manufacturing by the method of FIGS. 8A through 8K.

It can be observed that the central axis of the electron emission region 330 is aligned with the central axis of the opening 320a of the gate electrode.

In addition, according to the electron emission device, it was observed that the central axis of the electron emission region is deviated from the central axis of the opening of the gate electrode by less than 0.5 μm.

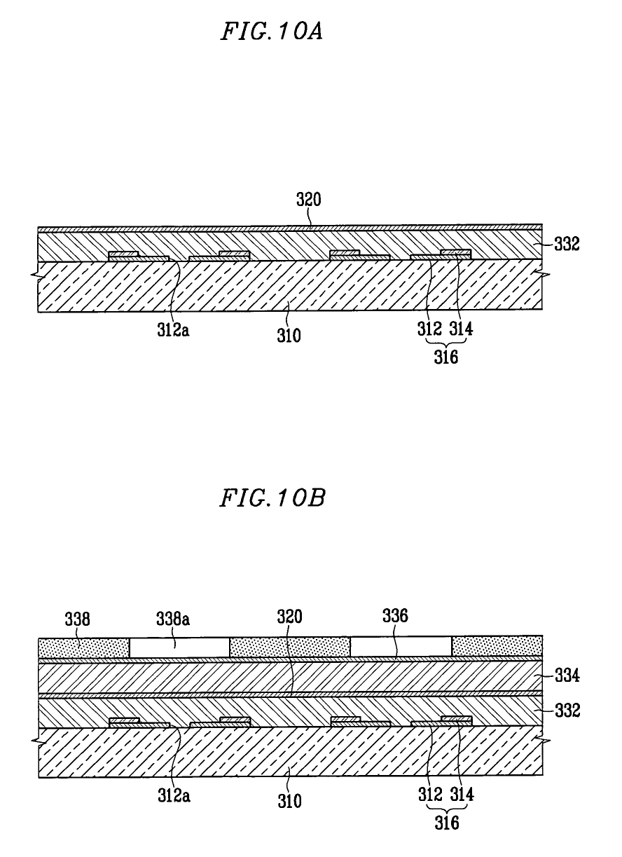

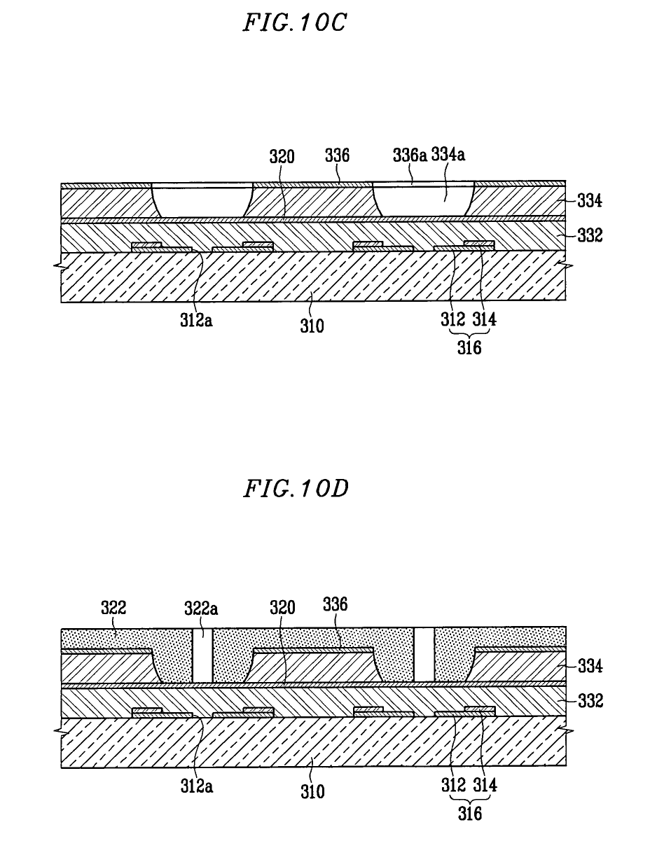

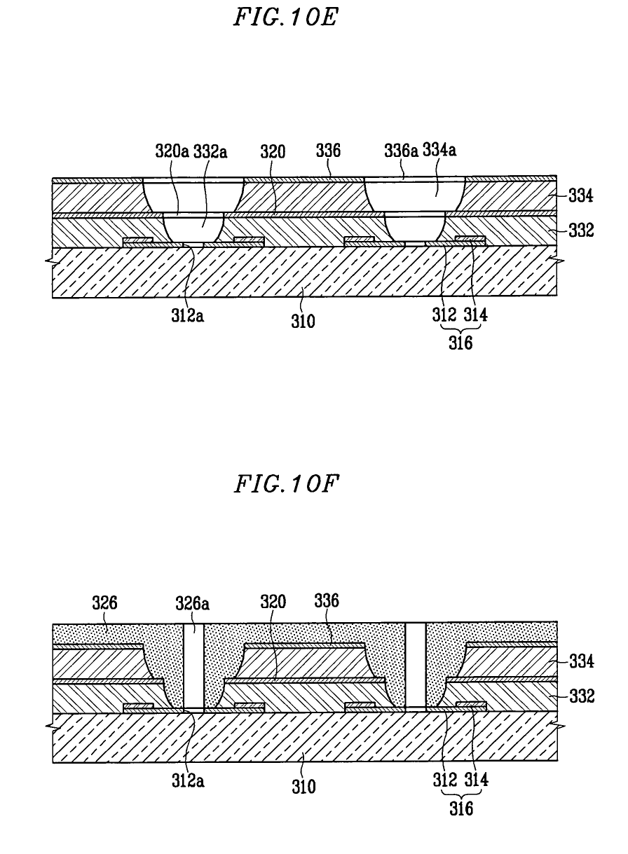

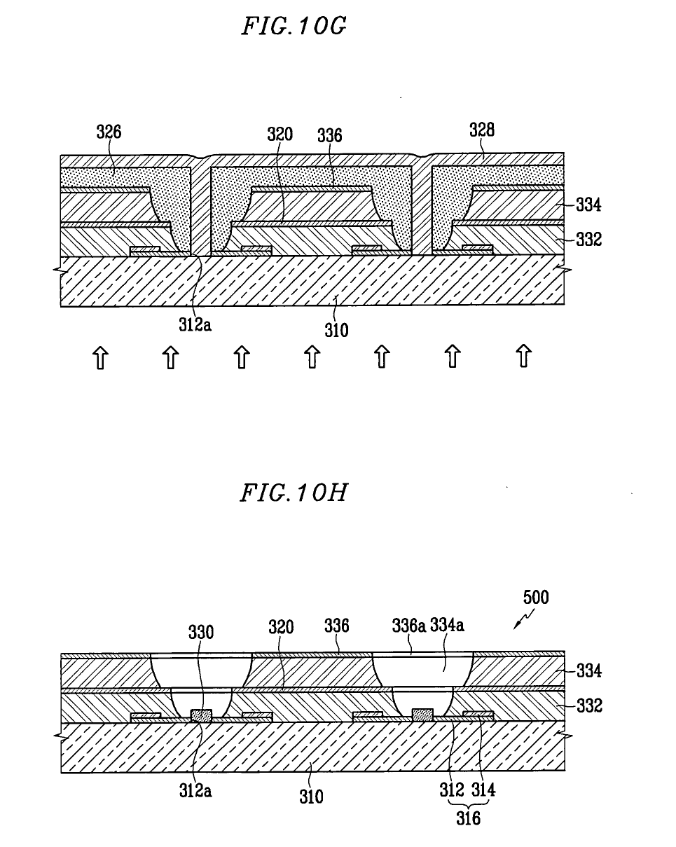

FIGS. 10A through 10H are sectional views illustrating a method of manufacturing an electron emission device according to another embodiment of the present invention.

Referring to FIG. 10A, cathode electrodes 316 having a resistive layer 312 and a conductive layer 314 are formed on the substrate 310 and an insulation layer 332 that is transparent is formed on the substrate 310 while covering the cathode electrodes 316. A transparent conductive layer is coated on the first conductive layer 332 in a stripe pattern to form gate electrodes 320 crossing the cathode electrodes 316.

Referring to FIGS. 10B and 10C, a second insulation layer 334 is formed on the substrate to cover the gate electrode 320. A focusing electrode 336 formed of metal is formed on the second insulation layer 334. Then, a mask layer 338 is formed on the focusing electrode 336 and an opening 338a is formed through the mask layer 338.

An exposed portion of the focusing electrode 336 by the opening 338a of the mask layer 338 and a portion of the second insulation layer 334, which corresponds to the exposed portion of the focusing electrode 336, are successively etched to form openings 336a, 334a through the focusing electrode 336 and second insulation layer 334. At this point, the size of the opening 338a of the mask layer 338 is formed to be greater than that of the opening 312a of the resistive layer 312 so that sizes of the openings 336a, 334a of the focusing electrode 336 and second insulation layer 334 can be greater than that of the opening 312a of the resistive layer 312.

Referring to FIG. 10D, a first photoresist layer 322 is formed on the substrate 310 to cover the focusing electrode 336 and ultraviolet light is emitted to a rear surface of the substrate to selectively expose the first photoresist layer 322 through the opening 312a of the resistive layer 312. The exposed portion of the first photoresist layer 322 is removed to form an opening 322a. In this embodiment, because the focusing electrode 336 is formed on the entire surface of the substrate 310, the light blocking mask can be omitted.

Then, an exposed portion of the gate electrode 320 by the opening 322a of the photoresist layer 322 and a portion of the first layer 332, which corresponds to the exposed portion of the gate electrode 320, are successively etched to form openings 320a, 332a through the gate electrode 320 and first insulation layer 332 as shown in FIG. 10E. Then, the first photoresist layer 322 is removed.

Referring to FIG. 10F, a second photoresist layer 326 is formed on the entire surface of the substrate 310 and ultraviolet light is emitted to a rear surface of the substrate 310 to selectively expose the second photoresist layer 326. The exposed portion of the second photoresist layer 326 is removed through a developing process to form an opening 326a. The second photoresist layer 326 selectively exposes a portion where the electron emission region will be formed.

Referring to FIGS. 10G and 10H, a paste mixture containing an electron emission material and a photoresist material is screen-printed, rear-exposed, and developed to form the electron emission region 330 through the opening 312a of the resistive layer, thereby completing an electron emission device 500.

As described above, even when the second insulation layer 334 and the focusing electrode 336 are further provided, the central axis of the electron emission region 330 can be accurately aligned with the central axis of the opening 320a of the gate electrode 320.

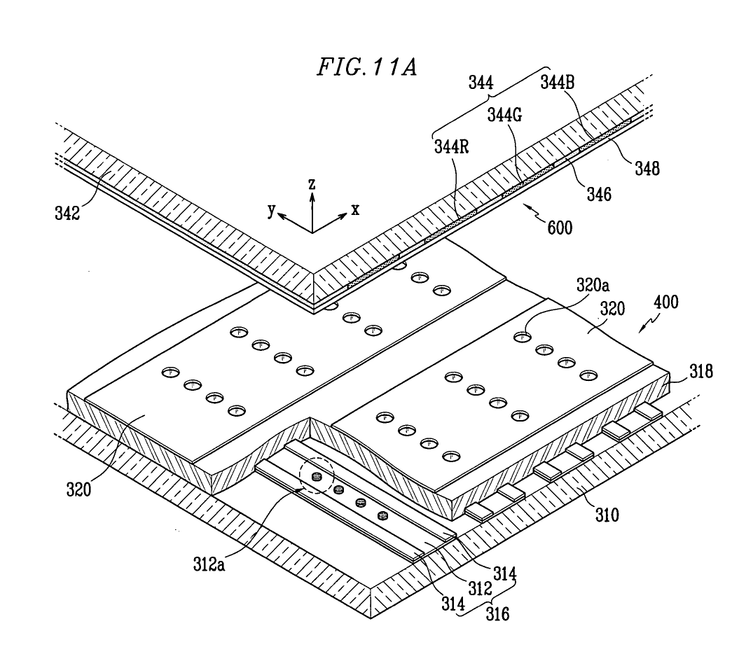

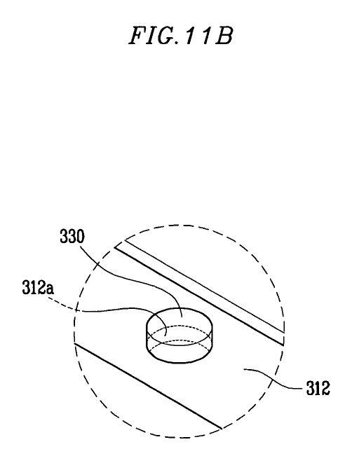

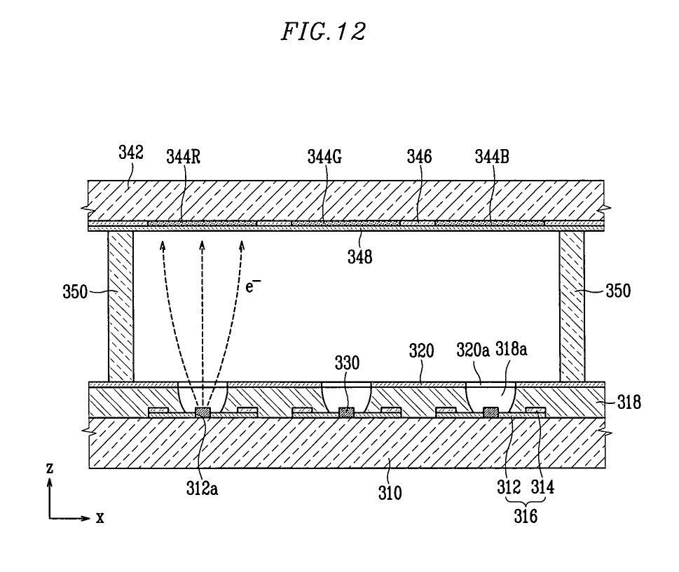

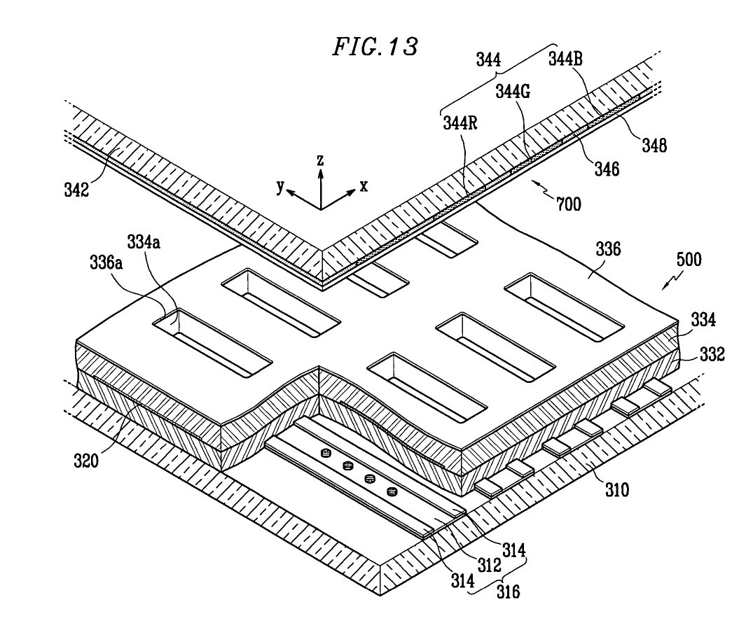

FIGS. 11A, 11B and 12 show an electron emission display having the electron emission device manufactured by the method of FIGS. 8A through 8K.

Referring to FIGS. 11A, 11B and 12, an electron emission display includes first and second substrates 310, 342 facing each other. The first and second substrates 310, 342 are sealed together at their peripheries using a sealing member (not shown). An inner space defined by the first and second substrates 310, 342 are exhausted to be kept to a degree of vacuum of about 10⁻⁶ torr.

A plurality of cathode electrodes 316 are arranged on the first substrate 310 in a stripe pattern extending in a direction of the first substrate 310 and an insulation layer 318 is formed on the first substrate 310 to cover the cathode electrodes 316. A plurality of gate electrodes 320 are arranged on the insulation layer 318 in a stripe pattern extending in a direction crossing the cathode electrodes 316 at right angles.

The cathode electrodes 316 include a resistive layer 312 and a conductive layer 314 formed on the resistive layer 312. Electron emission regions 330 are formed in the opening 312a of the resistive layer 312. The resistive layer 312 electrically connects the conductive layer 314 to the electron emission region 330 and functions to improve the emission uniformity of the electron emission regions 330. The insulation layer and the gate electrodes 320 are formed of a transparent material that can transmit ultraviolet light.

Defining each crossed area of the cathode and gate electrodes 316 and 320 as a unit pixel area, a plurality of openings 312a of the resistive layer 312 and a plurality of the electron emission regions 330 are formed along a length of the cathode electrode 316 at each unit pixel area. Openings 320a, 318a corresponding to the electron emission regions 330 are formed through the gate electrodes 320 and the insulation layer 318 to expose the electron emission regions 330.

The electron emission regions 330 are exactly aligned with the openings 320a of the gate electrodes 320 in a thickness direction (a direction of a z-axis in FIG. 11A) of the electron emission display. That is, it was observed that the central axis of the electron emission region 330 deviated from the central axis of the opening 320a of the gate electrode 320 by less than 0.5 μm.

Phosphor layers 344 such as red, green and blue phosphor layers 344R, 344G, 344B are formed on a surface of the second substrate 342 facing the first substrate 310 and a black layer 346 for enhancing the contrast of the image are formed between the phosphor layers 344.

An anode electrode 348 formed of a conductive material such as aluminum is formed on the phosphor and black layers 344, 346. The anode electrode 348 functions to heighten the screen luminance by receiving a high voltage required for accelerating the electron beams and reflecting the visible rays radiated from the phosphor layers 344 to the first substrate 310 toward the second substrate 342.

Alternatively, the anode electrode may be formed of a transparent conductive material, such as Indium Tin Oxide (ITO), instead of the metallic material. In this case, the anode electrode is placed on the second substrate and the phosphor and black layers are formed on the anode electrode. Alternatively, the anode electrode may include the transparent conductive layer and the metal layer. The phosphor layers 344, black layer 346 and anode electrode 348 form a light emission unit 600.

Disposed between the first and second substrates 310, 342 are spacers 350 (see FIG. 12) for uniformly maintaining a gap between the first and second substrates 310, 342. The spacers 350 are formed on the black layer 346 not to interfere with the emission of the phosphor layers 344.

The above-described electron emission display is driven by applying voltages to the cathode electrodes 316, gate electrodes 320 and anode electrode 348. For example, one of the cathode and gate electrodes 316, 320 receives a scan drive voltage to function as a scan electrode and the other receives a data drive voltage to function as a data electrode. The anode electrode 348 receives hundreds through thousands of volts of a positive DC voltage to accelerate the electron beam.

Then, an electric field is formed around the electron emission regions corresponding to the pixels where a voltage difference between the cathode and gate electrodes 316, 320 is higher than a threshold value and thus the electric emission regions emit electrons. The emitted electrons strikes the corresponding phosphor layers 344 by the high voltage applied to the anode electrode, thereby exciting the phosphor layers 344.

In the electron emission display of this embodiment, an alignment error between the openings 320a of the gate electrodes 320 and the electron emission regions 330 is minimized to enhance the emission uniformity of the electron emission regions 330, thereby enhancing the luminance uniformity of the pixels. In addition, because the size of the opening 320a of the gate electrode can be reduced, the integration of the electron emission regions 330 at each unit pixel area increases to improve the emission efficiency and the screen luminance.

FIG. 13 is a partial sectional view of an electron emission display having the electron emission device manufactured by the method of FIGS. 10A through 10H.

Referring to FIG. 13, an electron emission display of this embodiment is substantially identical to that shown in FIGS. 11A, 11B and 12 except that an electron emission device further includes a second insulation layer 334 and a focusing electrode 336. The focusing electrode 336 is formed of a non-transparent metal layer and provided with one opening 336a at each unit pixel area corresponding to each electron emission region 330.

The focusing electrode 336 receives 0 or several to tens volts of a negative DC voltage to focus the electron beams passing through the openings 336a of the focusing electrode 336.

In this embodiment, although a case in which the openings of the insulation layers are formed through a wet-etching process is provided, the present invention is not limited to this case. That is, the openings of the insulation layers may be formed by dry etching.

According to the present invention, because the conductive layer of the cathode electrodes functions as the mask, the openings can be automatically aligned with the electron emission regions in the following processes.

Therefore, the openings formed on different layers can be exactly aligned with each other without using many photo masks, thereby making it possible to manufacture a high resolution, large-sized electron emission device.

Although exemplary embodiments of the present invention have been shown and described, it will be appreciated by those skilled in the art that changes may be made in this embodiment without departing from the principles and spirit of the invention, the scope of which is defined in the claims and their equivalents.

What is claimed is:

1. A method of manufacturing an electron emission device, comprising:
forming a cathode electrode on a substrate, the cathode electrode including at least one non-transparent conductive layer provided with a cathode electrode opening;
forming a first insulation layer on an entire surface of the substrate while covering the cathode electrode, the first insulation layer being formed of a transparent material;
forming a gate electrode on the first insulation layer in a direction crossing the cathode electrode, the gate electrode being formed of a transparent conductive material;
forming a photoresist mask layer on the entire surface of the substrate;
forming a photoresist mask layer opening on the photoresist mask layer corresponding to the cathode electrode opening by emitting ultraviolet light to a rear surface of the substrate and developing the photoresist mask layer;
etching an exposed portion of the gate electrode by the photoresist mask layer opening and a portion of the first insulation layer, which corresponds to the exposed portion, thus creating a gate electrode opening and a first insulation layer opening; and
forming an electron emission region in the cathode electrode opening.

2. The method of claim 1, wherein forming the cathode electrode includes forming a first conductive layer, being transparent, and a second conductive layer, being non-transparent, the second conductive layer being provided with a second conductive layer opening and stacked on the first conductive layer.

3. The method of claim 2, wherein forming the gate electrode includes forming a third conductive layer, being transparent, and a fourth conductive layer, being non-transparent, the fourth conductive layer having a fourth conductive layer opening.

4. The method of claim 3, wherein forming the fourth conductive layer includes forming the fourth conductive layer such that a central axis of the fourth conductive layer opening is identical to a central axis of the second conductive layer opening and a size of the fourth conductive layer opening is greater than a size of the second conductive layer opening.

5. The method of claim 2, further comprising:
forming the first insulation layer opening in the first insulation layer through a wet-etching process.

6. The method of claim 1, wherein forming the electron emission region includes forming the electron emission region of a carbon-base material or a nanometer sized material through a screen-printing process.

7. The method of claim 1, wherein forming the electron emission region includes:
preparing a paste mixture containing a carbon-base material or a nanometer sized material and a photoresist material,
screen-printing the paste mixture on the entire surface of the substrate,
hardening the paste mixture filled in the second conductive layer opening by emitting ultraviolet light to a rear surface of the substrate, and removing the paste mixture that is not hardened.

8. The method of claim 1, further comprising:
forming a second insulation layer on the first insulation layer while covering the gate electrode after forming the gate electrode, the second insulation layer being formed of a transparent material;
forming a focusing electrode on the second insulation layer, the focusing electrode having a transparent conductive layer; and
etching corresponding portions of the focusing electrode and second insulation layer to the gate electrode opening of the gate electrode.

9. The method of claim 8, wherein etching corresponding portions includes:
forming the photoresist mask layer on the focusing electrode,
forming the photoresist mask layer opening on the photoresist mask layer by emitting ultraviolet light to a rear surface of the substrate,
etching an exposed portion of the focusing electrode by the photoresist mask layer opening and a corresponding portion of the second insulation layer to the exposed portion, and
removing the photoresist mask layer.

10. The method of claim 8, wherein forming the gate electrode includes forming a third conductive layer, being transparent, and a fourth conductive layer, being non-transparent.

11. The method of claim 8, wherein forming the fourth conductive layer includes forming the fourth conductive layer such that a central axis of the fourth conductive layer opening is identical to a central axis of the second conductive layer opening and a size of the fourth conductive layer opening is greater than a size of the second conductive layer opening.

12. The method of claim 8, further comprising:
forming the first insulation layer opening in the first insulation layer and a second insulation layer opening in the second insulation layer through a wet-etching process.

13. The method of claim 8, wherein forming the focusing electrode includes forming a fifth conductive layer, being transparent, and a sixth conductive layer, being non-transparent, the sixth conductive layer being stacked on the fifth conductive layer and having a sixth conductive layer opening.

14. The method of claim 13, wherein forming the sixth conductive layer includes forming the sixth conductive layer such that a central axis of the sixth conductive layer opening is identical to a central axis of the fourth conductive layer opening and a size of the sixth conductive layer opening is greater than a size of the fourth conductive layer opening.

15. The method of claim 2, further comprising:
forming a second insulation layer on the first insulation layer while covering the gate electrode after forming the gate electrode, the second insulation layer being formed of a transparent material;
forming a focusing electrode on the second insulation layer; and
partly etching the focusing electrode and the second insulation layer to form a focusing electrode opening on the focusing electrode and a second insulation layer opening on the second insulation layer at each crossed area of the cathode and gate electrodes.

16. The method of claim 15, wherein forming the gate electrode includes forming a third conductive layer, being transparent, and a fourth conductive layer, being non-transparent, the fourth conductive layer having a fourth conductive layer opening.

17. The method of claim 16, wherein forming the fourth conductive layer includes forming the fourth conductive layer such that a central axis of the fourth conductive layer opening is identical to a central axis of the second conductive layer opening and a size of the fourth conductive layer opening is greater than a size of the second conductive layer opening.

18. The method of claim 15, further comprising forming the first insulation layer opening in the first insulation layer and the second insulation layer opening through a wet-etching process.

19. The method of claim 1, wherein forming the cathode electrode includes:
forming a resistive layer having a resistive layer opening, and
forming a conductive layer stacked on the resistive layer and spaced apart from the resistive layer opening.

20. The method of claim 19, wherein forming the electron emission region includes:
etching an exposed portion of the gate electrode by the photoresist mask layer opening and a corresponding portion of the first insulation layer to the exposed portion;
forming a second photoresist layer on a resulting structure on the substrate;
forming a second photoresist layer opening on the second photoresist layer through a photolithography process; and
forming an electron emission material in the resistive layer opening through a deposition process.

21. The method of claim 19, wherein forming the resistive layer includes forming the resistive layer of amorphous silicon; and forming the conductive layer includes forming the conductive layer of metal.

22. The method of claim 19, wherein forming the resistive layer includes forming the resistive layer in a stripe pattern; and forming the conductive layer includes forming the conductive layer along both side peripheries of the resistive layer.

23. The method of claim 19, further comprising:
forming the first insulation layer opening in the first insulation layer through a wet-etching process, and
etching the gate electrode after the first insulation layer is etched, such that a size of the first insulator layer opening is identical to a size of the gate electrode opening.

24. The method of claim 20, wherein forming the electron emission region includes:
preparing a paste mixture containing an electron emission material and a photoresist material,
depositing the paste mixture on the second photoresist layer,
selectively hardening the paste mixture filled in the resistive layer opening through a rear surface exposing process,
removing the paste mixture that is not hardened, and
drying and baking the paste mixture filled in the resistive layer opening.

25. The method of claim 19, further comprising:
after forming the electron emission region, partly removing a surface of the electron emission region to activate the electron emission region.

26. The method of claim 19, wherein forming the photoresist mask layer opening includes:
arranging a light blocking mask on the rear surface of the substrate between the cathode electrodes.

27. The method of claim 19, further comprising:
after forming the gate electrode, forming a second insulation layer and a focusing electrode, and
partly etching the focusing electrode and the second insulation layer to form a focusing electrode opening on the focusing electrode and a second insulation layer opening on the second insulation layer.

28. The method of claim 27, wherein partly etching the focusing electrode and the second insulation layer includes:
etching such that a size of the focusing electrode opening and a size of the second insulation layer opening is greater than a size of the gate electrode opening and a size of the first insulation layer opening.

29. The method of claim 20, wherein forming the focusing electrode includes:
forming the focusing electrode of a non-transparent metal material to function as a light blocking mask during a process for exposing the second photoresist layer.

30. An electron emission device comprising:
a substrate;
a cathode electrode formed on the substrate, the cathode electrode including at least one non-transparent conductive layer having a cathode electrode opening;
an electron emission region filled in the opening; and
a gate electrode disposed above the cathode electrode and provided with a gate electrode opening exposing the electron emission region, the gate electrode being transparent.

31. The electron emission device of claim 30, wherein the cathode electrode includes a first conductive layer, being transparent, and a second conductive layer, being non-transparent, the second conductive layer being provided with a second conductive layer opening and stacked on the first conductive layer; and wherein
the electron emission region is filled in the second conductive layer opening on the first conductive layer.

32. The electron emission device of claim 31, wherein the gate electrode includes a third conductive layer, being transparent, and a fourth conductive layer, being non-transparent, the fourth conductive layer having a fourth conductive layer opening and being stacked on the third conductive layer.

33. The electron emission device of claim 32, wherein a central axis of the fourth conductive layer opening is identical to a central axis of the second conductive layer opening and a size of the fourth conductive layer opening is greater than a size of the second conductive layer opening.

34. The electron emission device of claim 31, further comprising:
a second insulation layer formed on the first insulation layer, the first insulation layer covering the gate electrode, and
a focusing electrode formed on the second insulation layer, the focusing electrode having a transparent conductive layer.

35. The electron emission device of claim 34, wherein the focusing electrode includes a fifth conductive layer, being transparent, and a sixth conductive layer, being non-transparent, the sixth conductive layer being stacked on the fifth conductive layer and having a sixth conductive layer opening.

36. The electron emission device of claim 31, wherein the second insulation layer is provided with a second insulation layer opening and the focusing electrode is provided with a focusing electrode opening, both the second insulation layer opening and the focusing electrode opening corresponding to the electron emission region.

37. The electron emission device of claim 30, wherein the cathode electrode includes a resistive layer having a resistive layer opening and a conductive layer stacked on the resistive layer while exposing the resistive layer opening; and
the electron emission region contacts the resistive layer and is filled in the resistive layer opening so that a central axis of the electron emission region is self-aligned with a central axis of the gate electrode opening.

38. The electron emission device of claim 37, wherein the central axis of the electron emission region deviates from the central axis of the gate electrode opening by less than 0.5 μm.

39. An electron emission display comprising:
an electron emission device including a first substrate, a cathode electrode formed on the substrate, the cathode electrode including at least one non-transparent conductive layer having a cathode electrode opening, an electron emission region filled in the cathode electrode opening, and a gate electrode disposed above the cathode electrode and provided with a gate electrode opening exposing the electron emission region, the gate electrode being transparent;
a second substrate facing the first substrate;
a phosphor layer formed on the second substrate; and
an anode electrode formed on the phosphor layer.

40. The electron emission display of claim 39, wherein the cathode electrode includes a first conductive layer, being transparent, and a second conductive layer, being non-transparent, the second conductive layer being provided with a second conductive layer opening and stacked on the first conductive layer; and
the electron emission region is filled in the second conductive layer opening on the first conductive layer.

41. The electron emission display of claim 40, wherein the gate electrode includes a third conductive layer, being transparent, and a fourth conductive layer, being non-transparent, the fourth conductive layer having a fourth conductive layer opening and being stacked on the third conductive layer.

42. The electron emission display of claim 39, wherein a central axis of the fourth conductive layer opening is identical to a central axis of the second conductive layer opening and a size of the fourth conductive layer opening is greater than a size of the second conductive layer opening.

43. The electron emission display of claim 41, further comprising:
a second insulation layer formed on the first insulation layer, the first insulation layer covering the gate electrode, and
a focusing electrode formed on the second insulation layer, the focusing electrode having a transparent conductive layer.

44. The electron emission display of claim 43, wherein the focusing electrode includes a fifth conductive layer, being transparent, and a sixth conductive layer, being non-transparent, the sixth conductive layer being stacked on the fifth conductive layer and having a sixth conductive layer opening.

45. The electron emission display of claim 43, wherein the second insulation layer is provided with a second insulation layer opening, and the focusing electrode is provided with a focusing electrode opening, both the second insulation layer opening and the focusing electrode opening correspond to the electron emission region.

46. The electron emission display of claim 39, wherein the cathode electrode includes a resistive layer having a resistive layer opening and a conductive layer stacked on the resistive layer while exposing the resistive layer opening; and
the electron emission region contacts the resistive layer and is filled in the resistive layer opening so that a central axis of the electron emission region is self-aligned with a central axis of the gate electrode opening.

47. The electron emission device of claim 39, wherein the central axis of the electron emission region deviates from the central axis of the gate electrode opening by less than 0.5 μm.
